(19) United States
(12) Patent Application Publication
(10) Pub. No.: US 2024/0357113 A1
(43) Pub. Date: Oct. 24, 2024

(54) SYSTEMS AND METHODS FOR PROCESSING VIDEO CONTENT BASED ON VIEWING CONDITIONS

(71) Applicant: InterDigital CE Patent Holdings, SAS, Paris (FR)

(72) Inventors: Erik Reinhard, Hédé-Bazouges (FR); Patrick Morvan, Laille (FR); Edouard Francois, Bourg des Comptes (FR); Christel Chamaret, Chantepie (FR)

(73) Assignee: InterDigital CE Patent Holdings, SAS, Paris (FR)

(21) Appl. No.: 18/684,302

(22) PCT Filed: Aug. 15, 2022
(86) PCT No.: PCT/EP2022/072746

§ 371 Date: Feb. 16, 2024

(30) Foreign Application Priority Data
Aug. 16, 2021 (EP) 21306120.3

(51) Int. Cl. H04N 19/127; H04N 19/70

(52) U.S. Cl. CPC H04N 19/127; H04N 19/70

(57) ABSTRACT

Systems, methods, and instrumentalities are disclosed for adapting media (e.g., video) processing operations and/or parameters based on one or more viewing conditions in a media environment (e.g., to achieve power saving). Such viewing conditions may include a distance between a display device and a viewer, a viewpoint or viewing direction of the viewer towards the display device, and/or an ambient light level in the media environment. Aspects of the medical processing that may be adapted based on the viewing conditions may be associated with deblocking, sample adaptive offset (SAO) filtering, adaptive loop filtering (ALF), cross component adaptive loop filtering (CCALF), motion compensation, post-inter prediction processing, bi-prediction, residual scaling, luma mapping, chroma residual scaling (LMCS), geometric block partitioning, HDR signal reconstruction, etc.

### CROSS REFERENCE TO RELATED APPLICATIONS

This application claims the benefit of European Provisional Patent Application No. 21306120.3, filed Aug. 16, 2022, the contents of which is hereby incorporated by reference herein.

### BACKGROUND

Reduction of energy consumption is becoming a driver for innovation and business development. It has been suggested that the use of information and communication technologies (e.g., including data centers, end user devices, communication networks, etc.) may consume over 1100 terawatt-hour of electricity a year, accounting for 5.5% of all energy consumed globally, and the carbon footprint of these technologies may continue to increase in the future. In this context, it may be desirable to reduce the energy consumption of various devices involved with making, delivering, and/or consuming media content, while minimizing the impact on user experience.

### SUMMARY

Systems, methods, and instrumentalities are disclosed for adapting media (e.g., video) processing operations and/or parameters based on the conditions of a media environment (e.g., to achieve power saving). A video decoding device in accordance with one or more of the embodiments disclosed herein may comprise a processor configured to obtain video content, determine one or more viewing conditions associated with the video content, process the video content for consumption based at least on the viewing conditions. For example, the processor may adapt at least one aspect of the decoding based on the one or more determined viewing conditions, where the aspect of the decoding adapted by the processor may be associated with at least one of filtering, motion compensation, luma mapping, chroma mapping, chroma residual scaling, motion vector refinement, optical flow-based refinement, block partitioning, or a prediction mode of the video content. In examples, the processor may obtain information (e.g., from a video encoding device and/or via one or more supplemental enhancement information (SEI) message) that may indicate whether the video decoding device is allowed to adapt the at least one aspect of the decoding and the processor may adapt the at least one aspect of the decoding further based on the obtained information. In examples, the processor may obtain information (e.g., from a video encoding device and/or via one or more SEI messages) that may indicate a quality or complexity impact associated with adapting the at least one aspect of the decoding, and the processor may adapt the at least one aspect of the decoding further based on the obtained information.

The one or more viewing conditions described herein may include a distance between a viewer of the video content and a display device for the video content, a viewing angle of the viewer towards the display device, a size or resolution of the display device, a luminance (e.g., peak and/or average luminance) of the display device, or an ambient light level in a vicinity of the viewer or the display device. The video decoding device may be configured to determine the one or more viewing conditions, for example, by obtaining (e.g., from a camera or a sensor) information regarding a media environment in which the video content is consumed, and determining the one or more viewing conditions based on the obtained information.

In examples, the video decoding device being configured to adapt the at least one aspect of the decoding based on the one or more determined viewing conditions may comprise the video decoding device being configured to determine, based on the one or more determined viewing conditions, whether to apply an adaptive loop filter, a sample adaptive offset filter, or a cross component adaptive loop filter to the video content, or whether to decrease a strength or the filter length of a deblocking filter for the video content. In examples, the video decoding device being configured to adapt the at least one aspect of the decoding based on the one or more determined viewing conditions may comprise the video decoding device being configured to determine, based on the one or more determined viewing conditions, whether to decrease a length (e.g., number of taps) of an interpolation filter for the video content, whether to decrease an accuracy of motion compensation (e.g., based on the accuracy of one or more interpolation filters) for the video content, whether to apply luma mapping, chroma mapping, or chroma residual scaling for the video content, whether to apply decoder-side MV refinement for the video content, or whether to apply bi-directional optical flow or prediction refinement with optical flow for the video content. In examples, the video decoding device being configured to adapt the at least one aspect of the decoding based on the one or more determined viewing conditions may comprise the video decoding device being configured to determine, based on the one or more determined viewing conditions, whether to apply bi-prediction or uni-prediction to the video content. In examples, the at least one aspect of the decoding adapted by the video decoding device based on the one or more determined viewing conditions may be further associated with reconstructing the video content from a standard dynamic range (SDR) to a high dynamic range.

A video encoding device in accordance with one or more of the embodiments described herein may include a processor configured to obtain video content and encode the video content for decoding. The processor may be further configured to determine an impact of adapting at least one aspect of the decoding, and transmit a supplemental enhancement information (SEI) message to a video decoding device to indicate the impact of adapting the at least one aspect of the decoding. In examples, the impact associated with adapting the at least one aspect of the decoding may include an impact to the quality of the video content (e.g., image or video quality) or an impact to the complexity of the decoding. For instance, the impact may be a quality degradation or a complexity reduction. In examples, the SEI message may further indicate whether the at least one aspect of the decoding is allowed to be adapted. In examples, the SEI message may further indicate a ranking based on which one or more aspects of the decoding may be adapted.

The systems, methods, and instrumentalities described herein may include an media encoding device, a media decoding device, video data (e.g., a signal or bitstream), a computer-readable medium storing instructions for causing one or more processors to perform the methods described herein, and/or a computer program product including instructions which, when executed by one or more processors, cause one or more processors to carry out the methods described herein.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a block diagram illustrating an example of a video encoder.

FIG. 3 is a block diagram illustrating an example of a video decoder.

FIG. 4 is a block diagram illustrating an example of a system in which various aspects and examples of the present disclosure may be implemented.

FIG. 5 is a block diagram illustrating an example of a video processing architecture for achieving power saving or reduction.

FIG. 6 is a diagram illustrating examples of parameters that may impact the quality of experience (QoE) of a media consumer.

FIG. 7 is a diagram illustrating an example of a group of pictures (GOP) structure that may be used to prevent the propagation of quality degradation.

FIG. 8 is a diagram illustrating examples of viewing conditions that may impact the QoE of a media consumer.

FIG. 9 is a diagram illustrating an example of adapting aspects of video processing based on viewing conditions.

FIG. 10 is a block diagram illustrating an example of an HDR system to which one or more of the techniques described herein may be applied.

FIG. 11 is a flow diagram illustrating example operations associated with decoding video content based on one or more viewing conditions.

FIG. 12 is a flow diagram illustrating example operations associated with encoding video content.

### DETAILED DESCRIPTION

A more detailed understanding may be had from the following description, given by way of example in conjunction with the accompanying drawings.

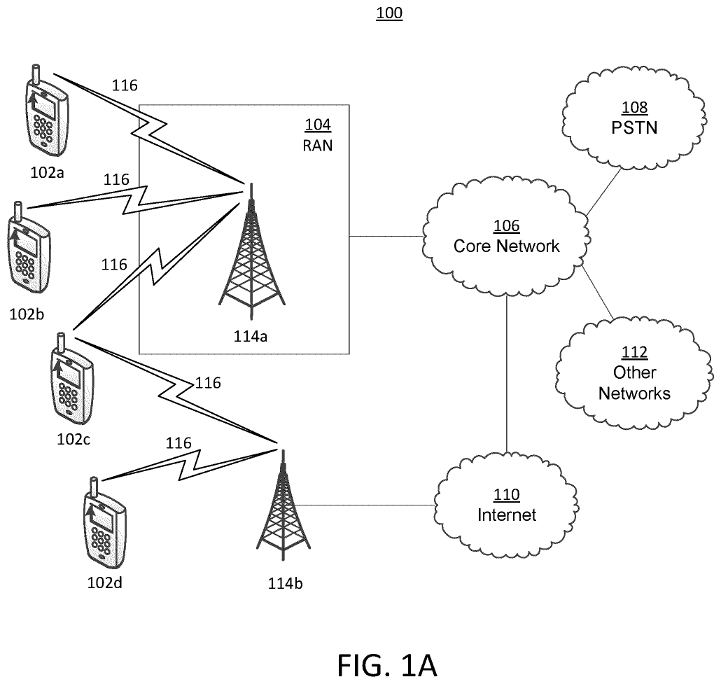

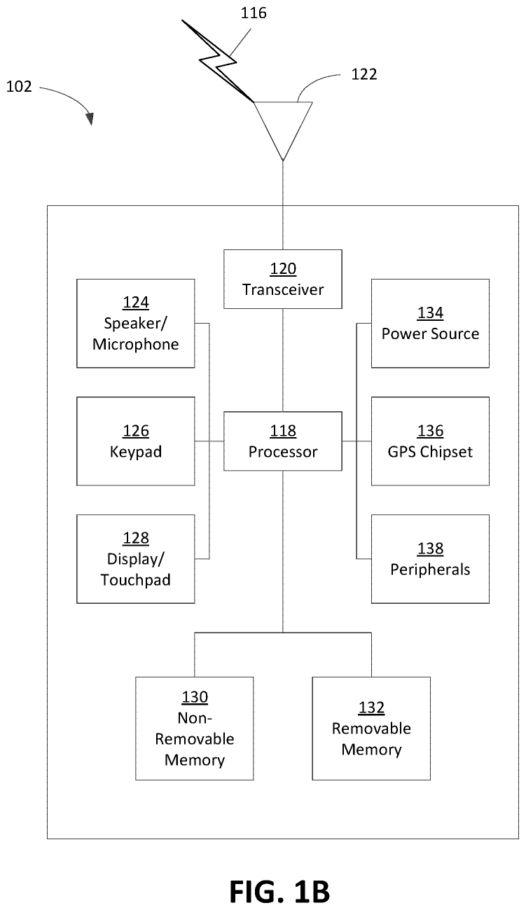

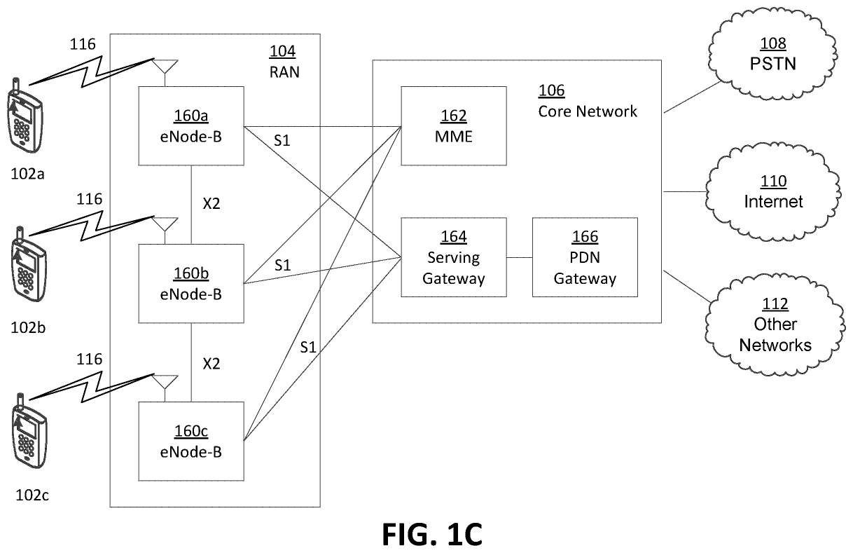

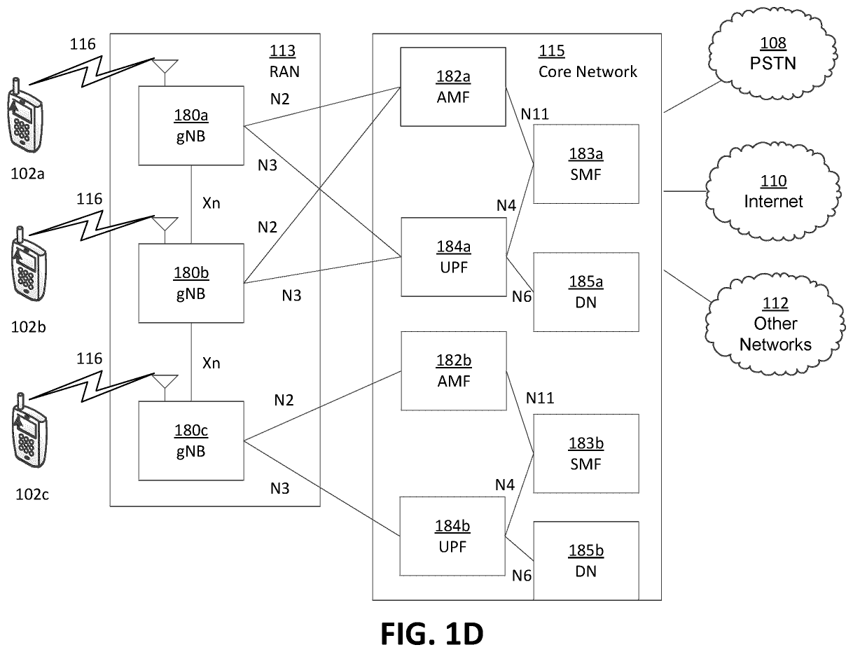

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

This application describes a variety of aspects, including tools, features, examples, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects may be combined and interchanged to provide further aspects. Moreover, the aspects may be combined and interchanged with aspects described in earlier filings as well.

The aspects described and contemplated in this application may be implemented in many different forms. The figures described herein may provide some examples, but other examples are contemplated. The discussion of the figures does not limit the breadth of the implementations. At least one of the aspects generally relates to video encoding and decoding, and at least one other aspect generally relates to transmitting a bitstream generated or encoded. These and other aspects may be implemented as a method, an apparatus, a computer readable medium (e.g., storage medium) comprising (e.g., having stored thereon) instructions for encoding or decoding video data according to any of the methods described, and/or a computer readable storage medium having stored thereon a bitstream generated according to any of the methods described.

In the present application, the terms “reconstructed” and “decoded” may be used interchangeably, the terms “pixel” and “sample” may be used interchangeably, the terms “image,” “picture” and “frame” may be used interchangeably.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various examples to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

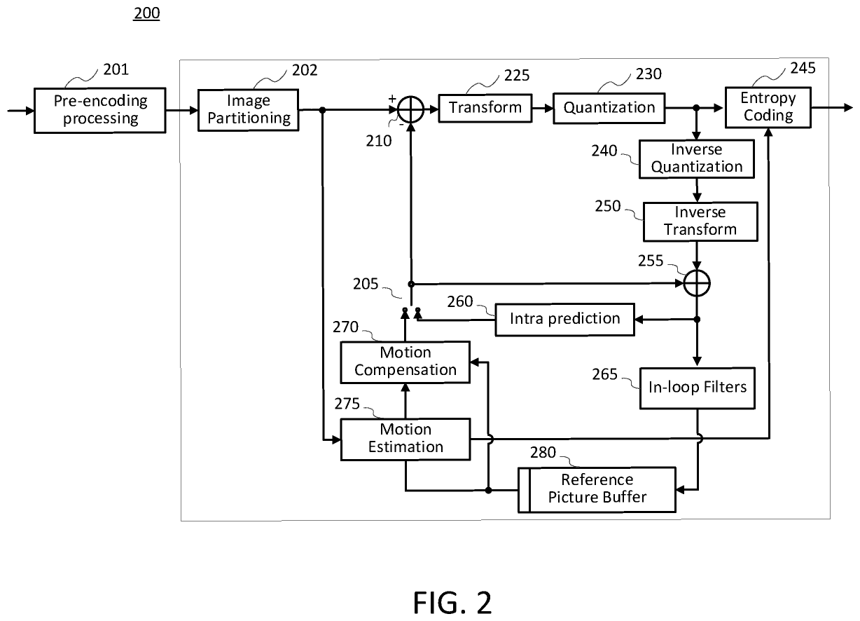

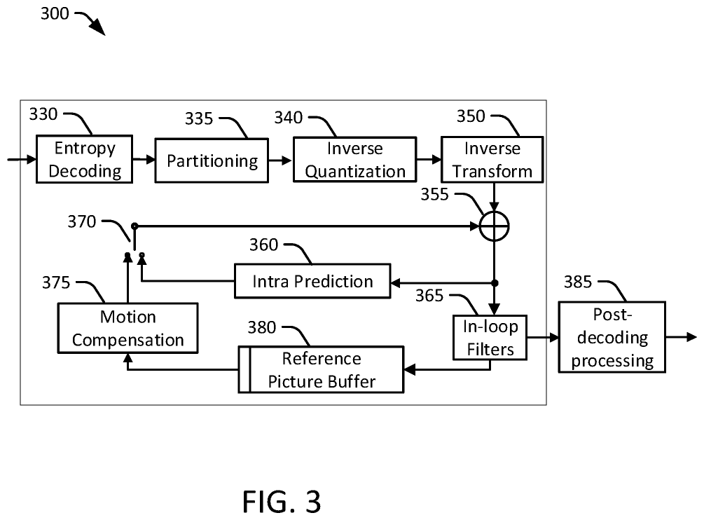

Various methods and other aspects described in this application may be used to modify modules, for example, decoding modules, of a video encoder 200 and decoder 300 as shown in FIG. 2 and FIG. 3. Moreover, the subject matter disclosed herein may be applied, for example, to any type, format or version of video coding, whether described in a standard or a recommendation, whether pre-existing or future-developed, and extensions of any such standards and recommendations. Unless indicated otherwise, or technically precluded, the aspects described in this application may be used individually or in combination.

Various numeric values are used in examples described the present application, such as numbers of bits, bit depth, etc. These and other specific values are for purposes of describing examples and the aspects described are not limited to these specific values.

FIG. 2 is a diagram showing an example video encoder. Variations of example encoder 200 are contemplated, but the encoder 200 is described below for purposes of clarity without describing all expected variations.

Before being encoded, the video sequence may go through pre-encoding processing 201, for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata may be associated with the pre-processing, and attached to the bitstream.

In the encoder 200, a picture is encoded by the encoder elements as described below. The picture to be encoded is partitioned 202 and processed in units of, for example, coding units (CUs). Each unit is encoded using, for example, either an intra or inter mode. When a unit is encoded in an intra mode, it performs intra prediction 260. In an inter mode, motion estimation 275 and compensation 270 are performed. The encoder decides 205 which one of the intra mode or inter mode to use for encoding the unit, and indicates the intra/inter decision by, for example, a prediction mode flag. Prediction residuals are calculated, for example, by subtracting 210 the predicted block from the original image block.

The prediction residuals are then transformed 225 and quantized 230. The quantized transform coefficients, as well as motion vectors and other syntax elements, are entropy coded 245 to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized 240 and inverse transformed 250 to decode prediction residuals. Combining 255 the decoded prediction residuals and the predicted block, an image block is reconstructed. In-loop filters 265 are applied to the reconstructed picture to perform, for example, deblocking/SAO (Sample Adaptive Offset) filtering to reduce encoding artifacts. The filtered image is stored at a reference picture buffer (280).

FIG. 3 is a diagram showing an example of a video decoder. In example decoder 300, a bitstream is decoded by the decoder elements as described below. Video decoder 300 generally performs a decoding pass reciprocal to the encoding pass as described in FIG. 2. The encoder 200 also generally performs video decoding as part of encoding video data.

In particular, the input of the decoder includes a video bitstream, which may be generated by video encoder 200. The bitstream is first entropy decoded 330 to obtain transform coefficients, motion vectors, and other coded information. The picture partition information indicates how the picture is partitioned. The decoder may therefore divide 335 the picture according to the decoded picture partitioning information. The transform coefficients are de-quantized 340 and inverse transformed 350 to decode the prediction residuals. Combining 355 the decoded prediction residuals and the predicted block, an image block is reconstructed. The predicted block may be obtained 370 from intra prediction 360 or motion-compensated prediction (i.e., inter prediction) 375. In-loop filters 365 are applied to the reconstructed image. The filtered image is stored at a reference picture buffer 380.

The decoded picture can further go through post-decoding processing 385, for example, an inverse color transform (e.g. conversion from YCbCr 4:2:0 to RGB 4:4:4) or an inverse remapping performing the inverse of the remapping process performed in the pre-encoding processing 201. The post-decoding processing can use metadata derived in the pre-encoding processing and signaled in the bitstream. In an example, the decoded images (e.g., after application of the in-loop filters 365 and/or after post-decoding processing 385, if post-decoding processing is used) may be sent to a display device for rendering to a user.

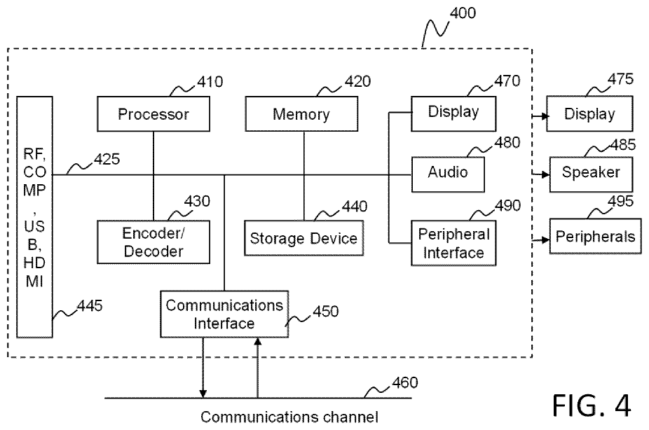

FIG. 4 is a diagram showing an example of a system in which various aspects and examples described herein may be implemented. System 400 may be embodied as a device including the various components described below and is configured to perform one or more of the aspects described in this document. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 400, singly or in combination, may be embodied in a single integrated circuit (IC), multiple ICs, and/or discrete components. For example, in at least one example, the processing and encoder/decoder elements of system 400 are distributed across multiple ICs and/or discrete components. In various examples, the system 400 is communicatively coupled to one or more other systems, or other electronic devices, via, for example, a communications bus or through dedicated input and/or output ports. In various examples, the system 400 is configured to implement one or more of the aspects described in this document.

The system 400 includes at least one processor 410 configured to execute instructions loaded therein for implementing, for example, the various aspects described in this document. Processor 410 can include embedded memory, input output interface, and various other circuitries as known in the art. The system 400 includes at least one memory 420 (e.g., a volatile memory device, and/or a non-volatile memory device). System 400 includes a storage device 440, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 440 can include an internal storage device, an attached storage device (including detachable and non-detachable storage devices), and/or a network accessible storage device, as non-limiting examples.

System 400 includes an encoder/decoder module 430 configured, for example, to process data to provide an encoded video or decoded video, and the encoder/decoder module 430 can include its own processor and memory. The encoder/decoder module 430 represents module(s) that may be included in a device to perform the encoding and/or decoding functions. As is known, a device can include one or both of the encoding and decoding modules. Additionally, encoder/decoder module 430 may be implemented as a separate element of system 400 or may be incorporated within processor 410 as a combination of hardware and software as known to those skilled in the art.

Program code to be loaded onto processor 410 or encoder/decoder 430 to perform the various aspects described in this document may be stored in storage device 440 and subsequently loaded onto memory 420 for execution by processor 410. In accordance with various examples, one or more of processor 410, memory 420, storage device 440, and encoder/decoder module 430 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some examples, memory inside of the processor 410 and/or the encoder/decoder module 430 is used to store instructions and to provide working memory for processing that is needed during encoding or decoding. In other examples, however, a memory external to the processing device (for example, the processing device may be either the processor 410 or the encoder/decoder module 430) is used for one or more of these functions. The external memory may be the memory 420 and/or the storage device 440, for example, a dynamic volatile memory and/or a non-volatile flash memory. In several examples, an external non-volatile flash memory is used to store the operating system of, for example, a television. In at least one example, a fast external dynamic volatile memory such as a RAM is used as working memory for video encoding and decoding operations.

The input to the elements of system 400 may be provided through various input devices as indicated in block 445. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 4, include composite video.

In various examples, the input devices of block 445 have associated respective input processing elements as known in the art. For example, the RF portion may be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which may be referred to as a channel in certain examples, (iv) demodulating the downconverted and band-limited signal, (v) performing error correction, and/or (vi) demultiplexing to select the desired stream of data packets. The RF portion of various examples includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box example, the RF portion and its associated input processing element receives an RF signal transmitted over a wired (for example, cable) medium, and performs frequency selection by filtering, downconverting, and filtering again to a desired frequency band. Various examples rearrange the order of the above-described (and other) elements, remove some of these elements, and/or add other elements performing similar or different functions. Adding elements can include inserting elements in between existing elements, such as, for example, inserting amplifiers and an analog-to-digital converter. In various examples, the RF portion includes an antenna.

The USB and/or HDMI terminals can include respective interface processors for connecting system 400 to other electronic devices across USB and/or HDMI connections. It is to be understood that various aspects of input processing, for example, Reed-Solomon error correction, may be implemented, for example, within a separate input processing IC or within processor 410 as necessary. Similarly, aspects of USB or HDMI interface processing may be implemented within separate interface ICs or within processor 410 as necessary. The demodulated, error corrected, and demultiplexed stream is provided to various processing elements, including, for example, processor 410, and encoder/decoder 430 operating in combination with the memory and storage elements to process the datastream as necessary for presentation on an output device.

Various elements of system 400 may be provided within an integrated housing, Within the integrated housing, the various elements may be interconnected and transmit data therebetween using suitable connection arrangement 425, for example, an internal bus as known in the art, including the Inter-IC (I2C) bus, wiring, and printed circuit boards.

The system 400 includes communication interface 450 that enables communication with other devices via communication channel 460. The communication interface 450 can include, but is not limited to, a transceiver configured to transmit and to receive data over communication channel 460. The communication interface 450 can include, but is not limited to, a modem or network card and the communication channel 460 may be implemented, for example, within a wired and/or a wireless medium.

Data is streamed, or otherwise provided, to the system 400, in various examples, using a wireless network such as a Wi-Fi network, for example IEEE 802.11 (IEEE refers to the Institute of Electrical and Electronics Engineers). The Wi-Fi signal of these examples is received over the communications channel 460 and the communications interface 450 which are adapted for Wi-Fi communications. The communications channel 460 of these examples is typically connected to an access point or router that provides access to external networks including the Internet for allowing streaming applications and other over-the-top communications. Other examples provide streamed data to the system 400 using a set-top box that delivers the data over the HDMI connection of the input block 445. Still other examples provide streamed data to the system 400 using the RF connection of the input block 445. As indicated above, various examples provide data in a non-streaming manner. Additionally, various examples use wireless networks other than Wi-Fi, for example a cellular network or a Bluetooth® network.

The system 400 can provide an output signal to various output devices, including a display 475, speakers 485, and other peripheral devices 495. The display 475 of various examples includes one or more of, for example, a touchscreen display, an organic light-emitting diode (OLED) display, a curved display, and/or a foldable display. The display 475 may be for a television, a tablet, a laptop, a cell phone (mobile phone), or other device. The display 475 can also be integrated with other components (for example, as in a smart phone), or separate (for example, an external monitor for a laptop). The other peripheral devices 495 include, in various examples, one or more of a stand-alone digital video disc (or digital versatile disc) (DVD, for both terms), a disk player, a stereo system, and/or a lighting system. Various examples use one or more peripheral devices 495 that provide a function based on the output of the system 400. For example, a disk player performs the function of playing the output of the system 400.

In various examples, control signals are communicated between the system 400 and the display 475, speakers 485, or other peripheral devices 495 using signaling such as AV.Link, Consumer Electronics Control (CEC), or other communications protocols that enable device-to-device control with or without user intervention. The output devices may be communicatively coupled to system 400 via dedicated connections through respective interfaces 470, 480, and 490. Alternatively, the output devices may be connected to system 400 using the communications channel 460 via the communications interface 450. The display 475 and speakers 485 may be integrated in a single unit with the other components of system 400 in an electronic device such as, for example, a television. In various examples, the display interface 470 includes a display driver, such as, for example, a timing controller (T Con) chip.

The display 475 and speakers 485 can alternatively be separate from one or more of the other components, for example, if the RF portion of input 445 is part of a separate set-top box. In various examples in which the display 475 and speakers 485 are external components, the output signal may be provided via dedicated output connections, including, for example, HDMI ports, USB ports, or COMP outputs.

The examples may be carried out by computer software implemented by the processor 410 or by hardware, or by a combination of hardware and software. As a non-limiting example, the examples may be implemented by one or more integrated circuits. The memory 420 may be of any type appropriate to the technical environment and may be implemented using any appropriate data storage technology, such as optical memory devices, magnetic memory devices, semiconductor-based memory devices, fixed memory, and removable memory, as non-limiting examples. The processor 410 may be of any type appropriate to the technical environment, and can encompass one or more of microprocessors, general purpose computers, special purpose computers, and processors based on a multi-core architecture, as non-limiting examples.

Various implementations include decoding. “Decoding”, as used in this application, can encompass all or part of the processes performed, for example, on a received encoded sequence in order to produce a final output suitable for display. In various examples, such processes include one or more of the processes typically performed by a decoder, for example, entropy decoding, inverse quantization, inverse transformation, and differential decoding. In various examples, such processes also, or alternatively, include processes performed by a decoder of various implementations described in this application, for example, dequantization, inverse transformation, and obtaining precision factors (e.g., precision factors may have one or more precision values to be used in an encoder or decoder operation, or one or more shift values to be used in a quantization or dequantization process), etc.

As further examples, in one example “decoding” refers only to entropy decoding, in another example “decoding” refers only to differential decoding, and in another example “decoding” refers to a combination of entropy decoding and differential decoding. Whether the phrase “decoding process” is intended to refer specifically to a subset of operations or generally to the broader decoding process will be clear based on the context of the specific descriptions and is believed to be well understood by those skilled in the art.

Various implementations include encoding. In an analogous way to the above discussion about “decoding”, “encoding” as used in this application can encompass all or part of the processes performed, for example, on an input video sequence in order to produce an encoded bitstream. In various examples, such processes include one or more of the processes typically performed by an encoder, for example, partitioning, differential encoding, transformation, quantization, and entropy encoding. In various examples, such processes also, or alternatively, include processes performed by an encoder of various implementations described in this application, for example, performing quantization, transformation, and obtaining precision factors (e.g., precision factors may have one or more precision values to be used in an encoder or decoder operation, or one or more shift values to be used in a quantization or dequantization process), etc.

As further examples, in one example “encoding” refers only to entropy encoding, in another example “encoding” refers only to differential encoding, and in another example “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

Note that syntax elements as used herein, for example, coding syntax on intra prediction mode index, probability, block context, etc., are descriptive terms. As such, they do not preclude the use of other syntax element names.

When a figure is presented as a flow diagram, it should be understood that it also provides a block diagram of a corresponding apparatus. Similarly, when a figure is presented as a block diagram, it should be understood that it also provides a flow diagram of a corresponding method/process.

The implementations and aspects described herein may be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus may be implemented in, for example, appropriate hardware, software, and firmware. The methods may be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one example” or “an example” or “one implementation” or “an implementation”, as well as other variations thereof, means that a particular feature, structure, characteristic, and so forth described in connection with the example is included in at least one example. Thus, the appearances of the phrase “in one example” or “in an example” or “in one implementation” or “in an implementation”, as well any other variations, appearing in various places throughout this application are not necessarily all referring to the same example.

Additionally, this application may refer to “determining” various pieces of information. Determining the information can include one or more of, for example, estimating the information, calculating the information, predicting the information, or retrieving the information from memory. Obtaining may include receiving, retrieving, constructing, generating, and/or determining.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. Encoder signals may include, for example, an encoding function on an input for a block using a precision factor, etc. In this way, in an example the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling may be used without transmitting (implicit signaling) to simply allow the decoder to know and select the particular parameter. By avoiding transmission of any actual functions, a bit savings is realized in various examples. It is to be appreciated that signaling may be accomplished in a variety of ways. For example, one or more syntax elements, flags, and so forth are used to signal information to a corresponding decoder in various examples. While the preceding relates to the verb form of the word “signal”, the word “signal” can also be used herein as a noun.

As will be evident to one of ordinary skill in the art, implementations may produce a variety of signals formatted to carry information that may be, for example, stored or transmitted. The information can include, for example, instructions for performing a method, or data produced by one of the described implementations. For example, a signal may be formatted to carry the bitstream of a described example. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on, or accessed or received from, a processor-readable medium.

Many examples are described herein. Features of examples may be provided alone or in any combination, across various claim categories and types. Further, examples may include one or more of the features, devices, or aspects described herein, alone or in any combination, across various claim categories and types. For example, features described herein may be implemented in a bitstream or signal that includes information generated as described herein. The information may allow a decoder to decode a bitstream, the encoder, bitstream, and/or decoder according to any of the embodiments described. For example, features described herein may be implemented by creating and/or transmitting and/or receiving and/or decoding a bitstream or signal. For example, features described herein may be implemented a method, process, apparatus, medium storing instructions (e.g., computer-readable medium), medium storing data, or signal. For example, features described herein may be implemented by a TV, set-top box, cell phone, tablet, or other electronic device that performs decoding. The TV, set-top box, cell phone, tablet, or other electronic device may display (e.g., using a monitor, screen, or other type of display) a resulting image (e.g., an image from residual reconstruction of the video bitstream). The TV, set-top box, cell phone, tablet, or other electronic device may receive a signal including an encoded image and perform decoding.

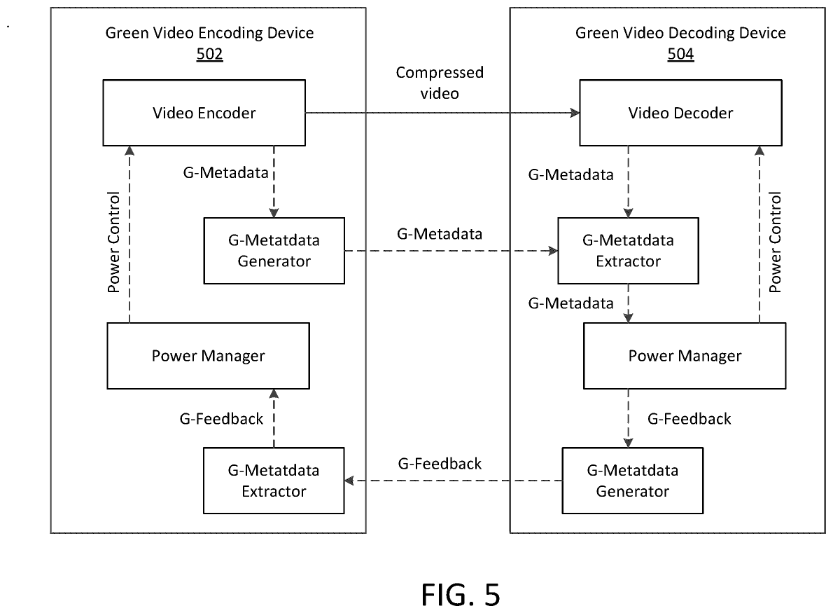

Energy-efficient media content (e.g., video content) consumption may be desirable. Power saving or reduction may be accomplished in various stages of a media processing pipeline (e.g., pre-processing, encoding, delivery, decoding, post-processing, display, etc.) without negatively impacting the quality of experience (QoE) of a medica consumer (e.g., a viewer of vide content). FIG. 5 illustrates an example of a video processing system architecture that may achieve power saving or reduction.

In the example video processing system shown in FIG. 5, a video encoding device 502 (e.g., referred to herein as an encoder) may generate metadata (e.g., G-metadata shown in the figure) that may indicate the complexity of a picture (e.g., a frame). The metadata may be used to adjust the power usage or consumption at a video decoding device 504 (e.g., referred to herein as a decoder). For instance, the power usage or consumption at the decoder may increase (e.g., linearly) with (e.g., as a function of) a clock frequency and/or (e.g., quadratically) with a voltage applied. This may be represented as P=f(V², F), where P may denote the power consumption, V may denote the voltage applied, and F may denote the clock frequency applied. Picture complexity (e.g., as indicated by the metadata described herein) may be used to (e.g., adaptively) control the processor frequency applied. For example, a lower processor frequency may be used to decode lower-complexity frames, and a higher processor frequency may be used to decode high-complexity frames. Such a technique may be used to save energy (e.g., on average) for other devices (e.g., an encoding device, a display, etc.) as well. For example, the metadata shown in FIG. 5 may be used to control the backlighting conditions of a display (e.g., referred to as Display Adaptation), for example, by dimming LCD backlight for certain types of media content and/or scaling RGB values in proportion to the dimming level (e.g., the RGB values may not have a strong influence on power consumption). In examples (e.g., when a return channel is available on a communication network such as the Internet), decoder 504 may generate feedback information (e.g., G-Feedback shown in FIG. 5) that encoder 502 may use to generate a video stream (e.g., a compressed video bitstream) that may demand less power in the decoder 504.

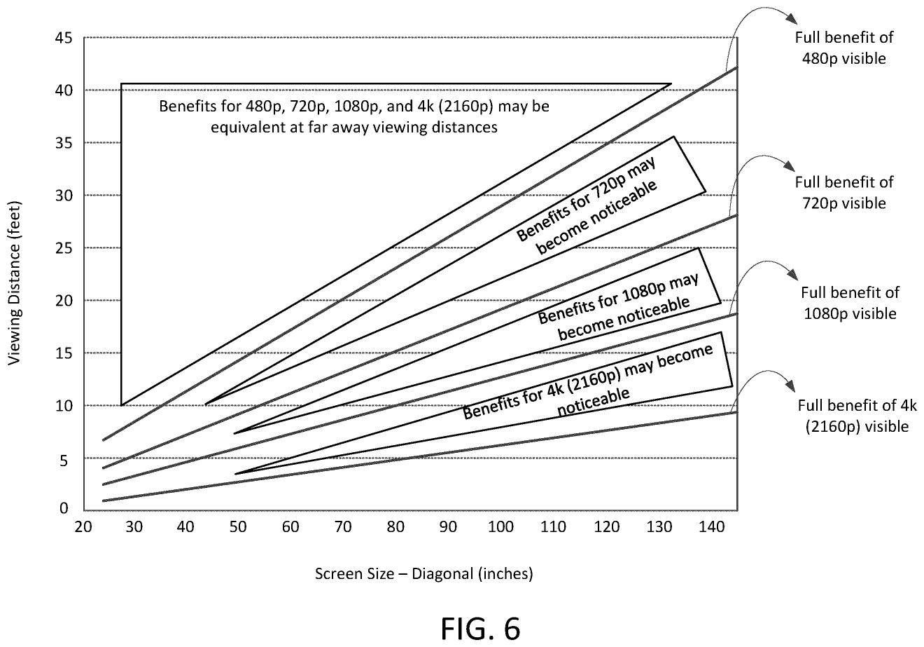

An example technique for reducing the energy consumption associated with streaming content may be to lower the resolution and/or quality of the streaming content. Such a technique may reduce the amount of data streamed, and/or the amount of work associated with processing (e.g., decoding) the streaming content. For example, a streaming service may offer streams in multiple levels of quality and/or resolution, and may (e.g., in adaptive streaming such as MPEG-DASH) provide a decoding device with a media presentation description (MPD) or manifest file that may include information regarding program timing, media content availability, media types and/or resolutions, minimum and/or maximum bandwidth, etc. of the streaming content. The decoding device may then select, based on the information included in the MPD or manifest file, the resolution and/or quality supported by the network on which the decoder is configured to operate. In some cases, however, the decoder may select the highest resolution and/or quality supported by the network, which may be higher than what may be acceptable or satisfactory to a user (e.g., a viewer or media consumer) given the user's media environment (e.g., viewing environment). For example, if the user is located far away from a display device such as a television screen, the quality and/or the resolution of the media content may be reduced (e.g., since each pixel may be projected to a smaller area of the retina). FIG. 6 illustrates how parameters such as screen sizes (e.g., diagonal screen sizes), viewing distances, and/or content resolutions may impact the quality of experience (QoE) of a media consumer. For example, given a same resolution (e.g., 4K), the longer a viewing distance is, the larger the screen's diagonal may be, without affecting the QoE of the medica consumer. Given a same diagonal screen size, the shorter a viewing distance is, the higher a pixel resolution may be. In examples, if the diagonal size of a TV is 80 inches, an optimal viewing distance may be around 5 feet (e.g., to get the full benefits of a 4K resolution). If the viewer is sitting further away from the TV such as 10 feet away, a satisfactory (e.g., maximum) QoE may be achieved with a 1080p HD resolution, and if the viewer is 16 feet away from the TV, a 720p HD pixel resolution may suffice.

In at least some situations, reducing the quality and/or the resolution of media content (e.g., a video stream) may have little or no impact on a viewer's QoE, but the reduction may have an impact on the energy used to deliver and/or process the media content. As screen sizes increase over the years, the average viewing distance may have stayed relatively unchanged (e.g., a median viewing distance has been estimated to be around 2.63 meters or 8.6 feet). Given such a median viewing distance, a HD resolution may be meaningful for a screen size of 45″ or more, while a 4K resolution may be desirable for a screen size of 70″ or more. Resolutions higher than 4K may not be meaningful at a viewing distance of 2.63 m for any screen size.

With the advent of 4K resolutions in televisions and the anticipated introduction of 8K televisions in the near future, the impact of media resolution (or high quality media content in general) may have a non-negligible impact on energy consumption, while the increase in real quality of experience may be modest in many viewing situations. As described herein, the median viewing distance may remain stable while the screen size (and/or resolution) of display devices continues to rise. This may lead to an increasingly large amount of energy being consumed for quality improvement that may go unnoticed. Accordingly, it may be desirable to reduce the amount of energy consumed at least where the reduction may not lead to a noticeable loss of QoE.

Techniques that may be used to reduce the energy consumption of a media device (e.g., an encoding device and/or a decoding device) may include adjusting the media device's operations and/or parameters (e.g., decoding operations and/or parameters) based on the conditions of a media environment (e.g., viewing distances, viewing angles, ambient light levels, display sizes, display luminance, etc.). Such a media device may include, for example, a decoding device (e.g., the decoder 300 shown in FIG. 3) configured to decode video content that may be received via broadcasting or streaming, or read from a storage medium. For example, when processing the video content, the decoding device may take the distance between a viewer and a display device into consideration, and adapt one or more operational aspects and/or parameters of the decoding device based on the distance such that the quality of experience of the viewer may be maintained while minimizing the amount of processing to reduce the amount of energy consumed by the decoding device.

The one or more operational aspects and/or parameters of the decoding device may also be adapted (e.g., controlled) based on other viewing conditions of the media environment (e.g., in addition to or in lieu of the viewing distance described above). These other viewing conditions may include, for example, a viewing angle of the viewer towards the display device, an ambient light level in the media environment (e.g., in the vicinity of the viewer and/or the display device), a size or resolution of the display device, a luminance (e.g., a peak or average luminance) of the display device, etc. The one or more aspects of the operation that may be adapted or controlled based on the viewing conditions may include, for example, enabling or disabling certain decoding operations (e.g., steps) and/or making certain decoding operations less computationally demanding (e.g., by simplifying or lowering the requirements for the decoding operations).

In examples, the decoding device may be configured to disable or decrease the strength of one or more of filtering operations (e.g., deblocking, sample adaptive offset (SAO) filtering, adaptive loop filtering (ALF), cross component adaptive loop filtering (CCALF), and/or bilateral filtering) in response to determining that a viewing condition has occurred. This may be because, for example, ALF and/or CCALF may contribute a non-negligible part to the decoding complexity, and while ALF and/or CCALF may improve signal fidelity, they may provide limited visual benefits. Thus, the visual impact of disabling such tools may be limited.

In examples, the decoding device may be configured to weaken the strength or extent of deblocking in response to determining that a viewing condition has occurred. The decoding device may be configured to control the strength of deblocking based on a parameter such as a boundary strength parameter (e.g., having a value between 0 and 4). For instance, the decoding device may apply a smaller value of the parameter (e.g., corresponding to a weaker deblocking filter) in response to determining that a viewing condition has occurred, and may apply a larger value of the parameter (e.g., corresponding to a stronger deblocking filter) in response to determining that the viewing condition has not occurred. The decoding device may be configured to apply a SAO band offset (e.g., with edge offset disabled) in response to determining that a viewing condition has occurred.

In examples, the decoding device may be configured to adjust motion compensation for the video content being decoded (e.g., by adjusting the length of one or more interpolation filters) in response to determining that a viewing condition has occurred. For instance, instead of using an 8-tap interpolation filter for a luma component and a 4-tap interpolation filter for a chroma component, the decoding device may use an interpolation filter with fewer taps for the luma and/or chroma components (e.g., a 4-tap interpolation filter for the luma component, a 2-tap interpolation filters for the chroma component, a 2-tap interpolation filter for both the luma and chroma components, etc.).

In examples, the decoding device may be configured to adjust a partitioning or prediction mode applied to the video content in response to determining that a viewing condition has occurred. For instance, the decoding device may be configured to replace a geometric block partitioning mode with a bi-directional prediction or uni-directional prediction mode in response to determining that the viewing condition has occurred. In the geometric block partitioning mode, a block may be split into two parts (e.g., two non-rectangular parts) and each part may be uni-predicted based on a respective reference picture and/or a respective motion vector (e.g., the reference picture and/or motion vector used for one part of the block may be different than those used for the other part of the block). Thus, using the geometric block partitioning mode, two uni-predictions may be performed on the block (e.g., the entire block) with each of the concerned motion vectors, and the two uni-predictions may be blended with weights that may depend on the spatial positions of the parts in the block. These operations may be simplified by the decoding device in response to determining that the viewing condition has occurred. For example, the decoding device may simplify the blending process by using the same weights for the block.

In examples, the decoding device may be configured to adapt a prediction mode applied to the video content in response to determining that a viewing condition has occurred. For instance, in response to determining that the viewing condition has occurred, the decoding device may be configured to simplify bi-prediction with coding unit level weights (BCW) by using ½ as the weights to blend two uni-predictions. As another example, the decoding device may be configured to replace bi-prediction with uni-prediction in response to determining that the viewing condition has occurred (e.g., the decoding device may use a reference picture from reference picture list LO or reference picture list L1 that may be temporally closest to the current picture for prediction, or the device decoder may use a reference picture from reference picture list L0 or reference picture list L1 that may have the lowest base quantization parameter (QP) for prediction). As yet another example, the decoding device may be configured to remove (e.g., omit or skip) a position-dependent prediction combination (PDPC) operation in intra prediction in response to determining that the viewing condition has occurred. As yet another example, the decoding device may be configured to replace combined intra-inter prediction (CIIP) by intra-only or inter-only prediction in response to determining that the viewing condition has occurred.

In examples, the decoding device may be configured to disable bi-directional optical flow (BIO or BDOF) and/or prediction refinement with optical flow (PROF) (e.g., which may be performed as post-inter prediction enhancement(s)) in response to determining that a viewing condition has occurred. In examples, the decoding device may be configured to disable an (e.g., any) operation associated with enhancing the intra-or inter-prediction of a coding block in response to determining that a viewing condition has occurred. In examples, the decoding device may be configured to disable decoder-side MV refinement (DMVR) (e.g., which may refine a decoded motion vector applicable to Bi-directional predicted pictures (B-pictures)) in response to determining that a viewing condition has occurred.

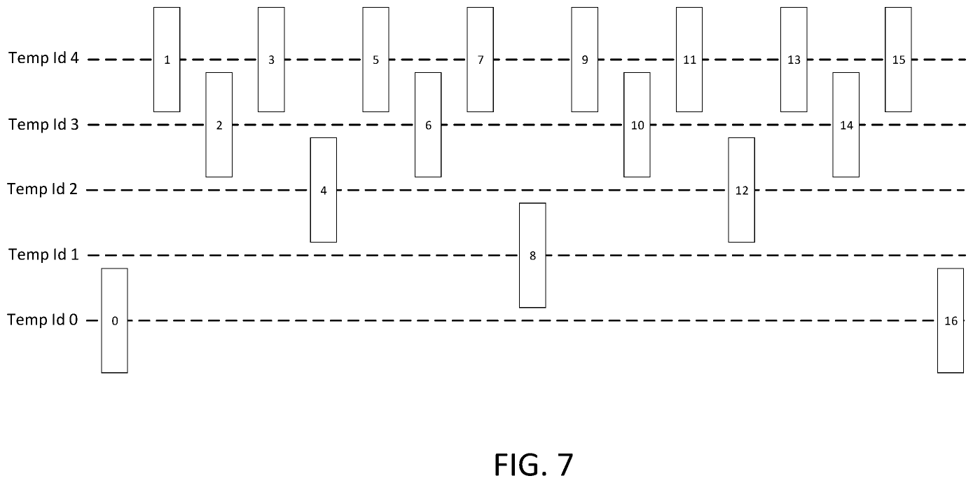

In examples, the decoding device may be configured to apply full decoding (e.g., without adapting the one or more operational aspects of the decoding device as described herein) to (e.g., only to) key pictures in response to determining that a viewing condition has occurred. Such key pictures may include, for example, pictures that may have a temporal ID of 0 and/or that may serve as a reference picture, directly or indirectly, for other pictures. In examples, the decoding device may be configured to apply light decoding operations (e.g., by adapting the one or more operational aspects of the decoding device as described herein) to certain pictures (e.g., those having a temporal ID larger than 0) in response to determining that a viewing condition has occurred, so that decoding degradation may apply only to those pictures (e.g., with no or only limited picture-to-picture propagation). FIG. 7 shows an example of a group of pictures (GOP) structure that may be used to prevent the propagation of video quality degradation. As shown, pictures with a given temporal ID may be predicted based on one or more pictures that have a lower (e.g., smaller) temporal ID or the same temporal ID. As such, if decoding complexity is reduced for a picture having a temporal ID larger than 1, decoding quality degradation may not propagate to pictures having a temporal ID lower than or equal to 1. In examples, the decoding device may be configured to skip the decoding of pictures of lower importance for prediction of other pictures (e.g., pictures of high temporal IDs).

In examples, the decoding device may be configured to not apply luma mapping with chroma residual scaling (LMCS) in response to determining that a viewing condition has occurred. In examples, the decoding device may be configured to not apply luma mapping in response to determining that a viewing condition has occurred. In examples, the decoding device may be configured to not apply chroma residual scaling (e.g., when luma mapping is enabled) or chroma mapping in response to determining that a viewing condition has occurred.

In examples, the decoding device may be configured to lower the accuracy of (e.g., avoid performing the most accurate) motion compensation for temporal prediction in response to determining that a viewing condition has occurred (e.g., an accurate or full motion vector accuracy may be a 1/16 pixel (pel) accuracy). The decoding device may, in those situations, limit motion compensation to a lower accuracy (e.g., perform ⅛, ¼, ½, or 1-pel interpolation dependent on the viewing condition such as a viewing distance).

The viewing condition(s) described herein may include or be related to various environment factors such as, for example, a viewing distance (e.g., between a display device and a viewer), a viewpoint or viewing angle (e.g., from a viewer's position towards a display device), an luminance of the display device such as a peak or average luminance (e.g., averaged over the display screen) of the display device, an amount of light (e.g., ambient light) in the media environment, a size and/or resolution of the display device, etc. And a determination that the viewing condition(s) may have occurred may be made by comparing a measurement associated with the condition with a corresponding threshold value (e.g., which may be configured or predetermined). For example, if the ambient light level in the media environment is high (e.g., above a configured or predetermined threshold), minor or slight quality losses may be masked (e.g., unnoticeable) because of the ambient light. As another example, if the viewer is determined to be not looking at the display (e.g., based on a viewing angle or gaze position of the viewer), video quality degradation may also be unnoticeable. As yet another example, if the display does not have a high luminance, the viewer may not see details in a picture and therefore decoding may be performed at a reduced level. Thus, in one or more (e.g., each) of the situations or examples described herein, decoding operations and/or parameters of the decoding device may be adjusted to reduce the energy consumption of the decoding device and/or the display, with no or minimal impact on the quality of experience of the viewer.

One or more of the following devices or components may be utilized to detect a viewing condition and/or to adapt the video processing operations and/or parameters (e.g., decoding operations and/or parameters, pre-processing and/or post-processing operations and/or parameters, etc.) based on the detected viewing condition. These device or components may include, for example, a display device such as a TV, a camera (e.g., including a depth camera), an eye/gaze tracking device, a luminance meter or sensor, a computing or media processing device (e.g., a decoding device), etc. The display or camera may be equipped with face detection hardware/software configured to identify a viewer, determine a viewing distance of the viewer, determine a viewpoint or viewing angle of the viewer, determining a gaze position of the viewer, etc. The camera may be a stand-alone device, or may be a part of the display device (e.g., built into a bezel of the display device) or a video decoding device (e.g., such as a set-top box). The luminance meter or sensor (e.g., which may be a part of the camera, the display device, or the decoding device) may be capable of detecting a light level in the media environment (e.g., as emitted by the display and/or other devices in the environment). The eye/gaze tracking device may be capable of determining whether the viewer is looking at the display device or away from the display device, and the computing or media processing device may be capable of determining that a certain viewing condition has occurred (e.g., based on signals generated by the display device, the camera, and/or the luminance sensor), and adapting one or more aspects of the media processing operation (e.g., as described herein) based on the determination.

The determination of viewing conditions and/or the adaptation of video processing operations may be illustrated by the following example.

A camera installed in a media environment may be configured to periodically (e.g., once every few seconds) take a picture of a viewing environment and analyze the picture for the presence of human faces indicative of the presence of one or more viewers (e.g., the camera may also transmit the picture to another processing device such as a video decoding device for analysis). The size of a detected human face (e.g., in pixels of the captured picture) may be correlated to (e.g., may be indicative of) the distance between a viewer and a display. Pupils of the viewer, e.g., if detected in the picture, may also be used to determine such a viewing distance (e.g., based on an interpupillary distance). The determined viewing distance may be used to calculate a projected solid angle of the display onto the retina of the viewer, and/or a projected solid angle of a pixel (e.g., a single pixel) onto the viewer's retina. For ease of description, it is assumed herein that a projected solid angle may be measured in square degrees (deg²) rather than in steradians, or that a horizontal screen angle may be used. The projected solid angle may be calculated based on the size of the display device and/or the distance of the viewer from the display device. Various viewing distances recommendations have been made for different display sizes. For instance, a recommended viewing distance for a 42″ television may be around 3.5 feet or 106 cm, and therefore a pixel may cover an angle (e.g., on the retina) of around 0.0126 deg. A 43″ 4K television may have a horizontal screen size of 95.3 cm including a total of 4096 pixels per scanline (e.g., 42.98 pixels/cm), and a pixel may span a length of 0.0233 cm. With a recommend viewing distance of between 3.6 and 5.4 feet (109.7 to 164.6 cm) for such a 43″ television, a pixel may cover an angle (e.g., on the retina) of between 0.0122 and 0.0081 deg. In other examples, recommendations have been made to keep a viewing distance at 5 times the screen width (e.g., to prevent eye strains). Based on such recommendations, a viewer may be located 476 cm away from a 42″ television, and a pixel may cover an angle (e.g., on the retina of a viewer) of around 0.0028 deg.

The human retina may have on average 199,000 cones/mm² in the central fovea where its resolving power may be the highest. The conversion (e.g., in the central fovea) between mm² and deg² may be given by a factor of 0.0795 mm²/deg². Thus, a single cone may cover a solid angle of 0.0000632 deg², or an angle of 0.00795 deg in a horizontal and/or a vertical direction. Taking the Nyquist limit into consideration, a contrast may be detected with two cones (e.g., a minimum of two cones), and image details may be resolved at angles equal to or greater than 0.0159 deg.

In view of the above, media content may be rendered (e.g., displayed) at a resolution lower than the resolution of a television (e.g., 4K in the above example), without negatively impacting the QoE of a viewer (e.g., the recommended viewing distance(s) described herein may be conservative at least in terms of the projected angle of individual pixels). If the viewer is sitting further away from a media display device than the recommended viewing distance, the resolution of the media content may be made even lower and further reduction in energy consumption may be accomplished, for example, by adjusting certain operations or parameters (e.g., decoding operations and/or parameters) associated with content delivery (e.g., by requesting a server such as a streaming server to send a lower resolution video stream) and/or content processing (e.g., by adapting the one or more operational aspects of a video decoding device as described herein). In examples (e.g., if multiple viewers are present), the viewing conditions associated with the viewer who is closest to the media display device may be determined and/or analyzed to determine media delivery and/or processing operations to be performed for all viewers in the environment.

In examples (e.g., where media content is available in different resolutions or qualities), the resolution or quality in which a video stream is requested may be determined based on not only the bandwidth available to a media processing device (e.g., on a home network), but also the conditions of the viewing environment (e.g., such as the distance between a viewer and a display). For instance, in a use case involving MPEG-DASH, the resolution and/or quality of media content may be selected (e.g., based on an MPD file) that may be the lower of a highest resolution/quality supported by the available bandwidth and a lowest acceptable resolution/quality given a viewer's location (e.g., viewing distance) from a display device.

A media processing device such as a decoder may determine a media (e.g., video) resolution and/or quality setting based on the projected pixel angle described above. For example, if no faces are detected in the media environment, a low (e.g., lowest) resolution and/or quality setting may be selected (and applied). Denoting a pixel resolution of the media content that may be projected to a viewer as x deg, the value of x may be related to a (e.g., the maximum) resolving angle of the human retina (e.g., 0.0159 deg, as described herein). The ratio between these two values, r=0.0159/x, may represent a value (e.g., a dimensionless value) indicating the potential for operation/parameter adjustments. For example, if r=1, a viewer may be at a correct viewing distance and a current video resolution/quality may be appropriate (e.g., no adjustment to the decoding process may be performed). If r<1, one or more operations and/or parameters (e.g., decoding operations and/or parameters) may be adjusted (e.g., reduced), for example, since the value of r may indicate that the viewer is too far away from a display device to enjoy the resolution/quality the display device is capable of providing. If r<0.5, the resolution/quality may be reduced (e.g., halved) in a (e.g., each) dimension, which may make it possible to switch from 4K resolution to HD resolution. If r<0.25, the resolution/quality may switch from 4K to SD, or may be reduced even further.

Even though the illustration above may be provided in the context of a projection angle, those skilled in the art will understand that the adjustments (e.g., adjustments to decoding operations and/or parameters) may also be made based on other environmental factors or viewing conditions including viewing distances, viewpoints or viewing angles, light levels in the environment, etc. For example, if the viewing environment becomes very bright, the state of a viewer may be such that a small quality degradation may not be visible. Likewise, if the screen of a display device is directly illuminated by a light source, the reflections off the screen may mask the quality of the media content. In such cases, the resolution or quality of the media content may also be lowered. One or more (e.g., each) of these environmental factors or viewing conditions may be measured with a camera or a light sensor (e.g., which may be located in a bezel of the display device), as described herein.

In examples, viewing conditions associated with a viewer may be determined (e.g., obtained) based on a vision test performed for the viewer. Such a test may provide, for example, visual acuity data and the data may be used to adjust one or more aspects of media content retrieval and/or rendering (e.g., if the viewer's vision is less than perfect, the quality or resolution of the media content may be reduced).

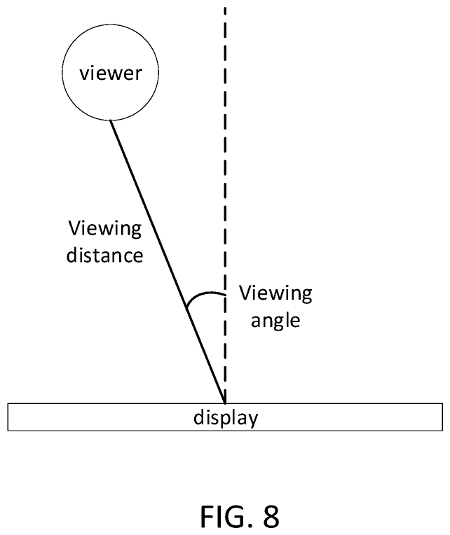

FIG. 8 illustrates how media processing operations and/or parameters (e.g., decoding operations, steps, or tools) may be adjusted or adapted based on one or more viewing conditions. As shown, such viewing conditions may include a viewing distance and/or a viewing angle (e.g., a viewpoint), although other conditions such as an ambient light level may also be considered.

In examples, media processing settings (e.g., tools and/or operations to be adjusted or disabled) may be grouped such that each group of settings may be applied (e.g., together) if a corresponding viewing condition is met. For instance, a first set (e.g., Set 1) of media processing settings (e.g., disablement and/or adjustment of decoding tools or operations) may be applied (e.g., activated) based on a first viewing condition such as a viewing distance, a second set (e.g., Set 2) of media processing settings may be applied based on a second viewing condition such as a viewing angle, and a third set (e.g., Set 3) of media processing settings may be applied based on a third viewing condition such as an ambient light level.

In examples, the first set (e.g., Set 1) of media processing settings may be applied when a viewing distance is larger than a first threshold value denoted Distance 1 (e.g., such a threshold value may depend on a display size and/or a display resolution), where the first set of media processing settings may correspond to one or more of the following: constraining in-loop filter tools (e.g., applying weak deblocking, disabling SAO, ALF, CCALF, and/or bilateral filtering etc.), constraining motion compensation (e.g., applying motion compensation with interpolation filters of a smaller length), constraining post-inter prediction tools (e.g., disabling DMVR, BIO, and/or PROF), and/or the like. In examples, another set (e.g., Set 1b) of media processing settings may be applied if the viewing distance is larger than a second threshold value (e.g., denoted Distance 2) that may be larger than the first threshold value described above. These settings may be based on the first set of media processing settings (e.g., Set 1) described above and further include, for example, replacing bi-prediction with uni-prediction.

In examples, the second set of media processing settings (e.g., Set 2) described above may be applied if a viewing angle (e.g., an absolute value of the viewing angle) towards a display is larger than a threshold value denoted Angle 1 (e.g., 45°), where the second settings may correspond to not applying chroma residual scaling and/or not applying CCALF.

In examples, the third set of media processing settings (e.g., Set 3) described above may be applied if an ambient light level in the viewing environment is larger than a threshold value denoted Luminance 1, where the third set of media processing settings may correspond to one or more of the following: not applying LMCS, constraining in-loop filter tools (e.g., applying weak deblocking, disabling SAO, ALF, CCALF, and/or bilateral filtering, etc.) for chroma components, constraining motion compensation (e.g., applying motion compensation with interpolation filters of a smaller length) for chroma components, constraining post-inter prediction tools (e.g., disabling DMVR, BIO, and/or PROF) for chroma components, and/or the like.

In examples, a hysteresis may be applied (e.g., for one or more of the viewing conditions or threshold values described herein) before an adjustment to the processing (e.g., decoding) operations is made. Application of such a hysteresis may, for example, prevent unwanted rapid switching between enabling and disabling certain processing tools or operations (e.g., SAO, ALF, CCALF, etc.).

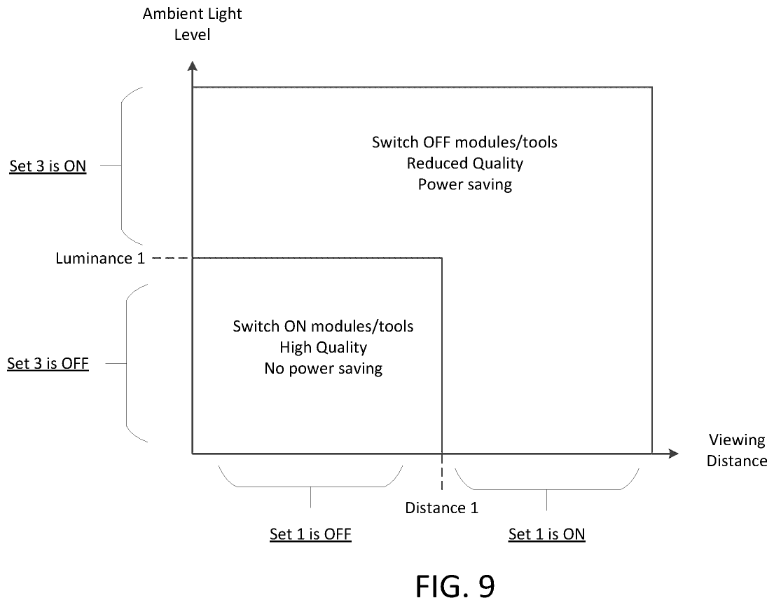

In examples, the settings described herein (e.g., Set 1, Set 1b, Set 2, and/or Set 3) may be combined depending on one or more of a viewing distance, a viewing angle, or an ambient light level. FIG. 9 shows an example of switching between Set 1 and Set 3 of the processing settings described herein in accordance with a viewing distance and an ambient light level. For instance, if the viewing distance is larger than Distance 1 or if the ambient light level is larger than Luminance 1, Set 1 and Set 3 may be activated (e.g., the relevant processing tools or operations may be switched off or weakened to achieve power saving at a reduced vide quality). If the viewing distance is smaller than Distance 1 and the ambient light level is smaller than Luminance 1, both Set 1 and Set 3 may be deactivated (e.g., the relevant processing tools or operations may be switched on to achieve a high video quality without power saving).

In examples (not shown in FIG. 9), if the viewing distance is larger than Distance 2 described above and the ambient light level is larger than Luminance 1 described above, Set 1b and Set 3 may be combined. In examples (not shown in FIG. 9), if the viewing angle is larger than Angle 1 described above and the ambient light level is larger than Luminance 1 described above, Set 2 and Set 3 may be combined.

In examples, a media encoding device such as the video encoder 200 shown in FIG. 2 may transmit (e.g., signal in a bitstream) information (e.g., metadata or an indication) to the decoding device described herein to indicate the impact of adjusting certain media processing tools or operations (e.g., activation or deactivation the tools or operations). The media encoding device may transmit the information, for example, in one more supplemental enhancement information (SEI) messages to help the decoding device to make decisions about which tools or operations may be activated, deactivated, or adjusted. Table 1 below shows example syntax for indicating the quality degradation impact of deactivating or constraining certain tools or operations. In examples, indications may be provided regarding the values of one or more objective quality metrics such as peak signal to noise ratio (PSNR), structure similarity (SSIM), and/or video multi-method assessment fusion (VMAF) values, or relative scores based on a given scale (e.g., a quality score from 0 to 100, 0 to 10, or 0 to 5 may be provided, where 0 may correspond to lowest possible quality, and 100, 10 or 5 may correspond to the highest possible quality). In examples, a flag may be indicated for a coding tool or constraint (e.g., for each coding tool or constraint) indicating whether the decoding device is authorized to apply the tool or constraint.

TABLE 1
Example Syntax for Indicating the
Quality Impact of Coding Constraints
Syntax

```
decoding_tools_impact_indication( payloadSize ) {
  sao_deactivation_quality_impact
  alf_deactivation_quality_impact
  ccalf_deactivation_quality_impact
  dbf_weak_quality_impact
  motion_comp_short_tap_quality_impact
  motion_comp_low_accuracy_quality_impact
  lmcs_deactivation_quality_impact
  chroma_scaling_deactivation_quality_impact
  dmvr_deactivation_quality_impact
  bio_deactivation_quality_impact
  prof_deactivation_quality_impact
}
```

The information (e.g., metadata) described above may be generated during the encoding of media content, or after the encoding and before distributing the media content (e.g., in a bitstream). If signaled, the information may apply to the picture(s) that are decoded after the information. When new information (e.g., new metadata) is signaled, it may cancel previously signaled (e.g., older) information and the new information may apply to one or more subsequent pictures. To determine the information (e.g., the quality impact), encoding of successive pictures may be performed. For each coding tool or operation involved (e.g., to be tested to determine the potential quality impact), information about the quality degradation associated with constraining the tool or operation (e.g., disabling or weakening the tool or operation, as described here) may be determined at a picture level (e.g., for each picture), and the quality impacts to multiple pictures may be combined, e.g., to derive an average quality impact to the multiple pictures. The information may then be provided (e.g., included in a bitstream as metadata) to the decoding device, for example, in the form of an SEI message.

In examples, the media encoding device may indicate the complexity impact (e.g., complexity reduction) to certain coding tools or operations to the decoding device. Such complexity impact may be determined based on, for example, a ratio of the processing time (e.g., decoding time) or number of operations by applying the tools or operations to the processing time or number of operations by not applying the tools or operations. Another complexity criterion can be the memory access bandwidth used by the tools or operations. For example, a ratio of processing time, ratioTime, may be determined as follows: ratioTime=dec_time_with_tool_constraint/dec_time_without_tool_constraint, where dec_time_with_tool_constraint may present a decoding time with a tool constraint and dec_time_without_tool_constraint may present a decoding time without the tool constraint. Similarly, a ratio of number of operations, ratioOp, may be determined as follows: ratioOp=nb_ops_with_tool_constraint/nb_ops_without_tool_constraint, where nb_ops_with_tool_constraint may represent a number of operations performed with the tool constraint and nb_ops_without_tool_constraint may represent a number of operations performed without the tool constraint. The determination and/or signaling of these complexity impacts may be performed in a similar manner as those for the quality impacts. Table 2 table shows example syntax for indicating these impacts. The quality impact value may be quantized, for instance in 3 levels, 0, 1, 2, to limit the coding cost of this information.

TABLE 2
Example Syntax for Indicating the
Complexity Impact of Coding Constraints
Syntax

```
decoding_tools_impact_indication( payloadSize ) {
  sao_deactivation_complexity_impact
  alf_deactivation_complexity_impact
  ccalf_deactivation_complexity_impact
  dbf_weak_complexity_impact
  motion_comp_short_tap_complexity_impact
  motion_comp_low_accuracy_complexity_impact
  lmcs_deactivation_complexity_impact
  chroma_scaling_deactivation_complexity_impact
  dmvr_deactivation_complexity_impact
  bio_deactivation_complexity_impact
  prof_deactivation_complexity_impact
}
```

In examples, coding tools or operations may be ranked (e.g., by an encoding device and/or a decoding device) based on the quality and/or complexity impact they may have on media content when they are disabled or constrained. If the ranking is determined by an encoding device, the ranking may be indicated to a decoding device, for example, so that the decoding device may use the ranking to determine which tools/operations may be disabled or constrained (and/or the order for disabling or constraining them) in different situations. Table 3 below shows an example ranking of coding tools or operations based on decreasing quality impact.

TABLE 3
Example Ranking of Coding Tools Based
on Decreasing Quality Impact

Alf
Motion comp short tap
Motion comp low accuracy
Lmcs
Dbf weak
Dmvr
Bio
Prof
Ccalf
Chroma scaling
Sao

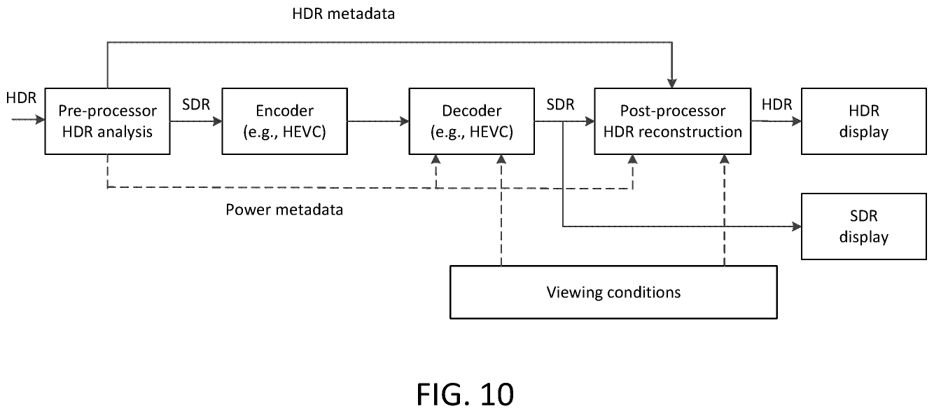

The techniques described herein may be applied to a high dynamic range (HDR) system (e.g., an end-to-end HDR system) such as a single layer HDR (e.g., SL-HDR1) system. FIG. 10 shows an example of such a system, which may be backward compatible and in which standard dynamic range (SDR) transmissions may be performed along with HDR metadata between a pre-processor and a post-processor. As shown, an HDR signal may be converted to an SDR signal by the pre-processor (e.g., on a production side), and HDR metadata may be generated (e.g., dynamically) and transmitted using SEI messages. The HDR signal may be reconstructed in a media device (e.g., a TV, a set-top box, etc.) using decoded SDR signal and the HDR metadata. The SDR signal may then be rendered on a regular display (e.g., without additional processing).

The viewing conditions described herein (e.g., viewing distance, viewing angle, ambient light level, etc.) may be used to control the tools or operations employed by the post-processor, for example, to limit the level of luminance (e.g., maximum luminance) so as to achieve power saving in an HDR display. For example, a set (e.g., Set 4) of constrains may be activated (e.g., applied) if a viewing distance is larger than a first threshold value (e.g., such as Distance 1 described herein, which may depend on a display size and/or a display resolution). In examples, Set 4 may include constraining one or more luminance mapping tools, such as applying a weak expansion to reconstruct the HDR signal from the SDR signal. In examples, Set 4 may include performing a passthrough (e.g., transmitting the SDR signal to the display without adaptation). In examples, a combination of viewing conditions may be defined to enable or disable tools or operations in the HDR post-processor so as to allow power saving in the display. Other modes of SL-HDR allows transmitting an HDR signal of given peak luminance, and the SLHDR post-process may convert the signal to another peak luminance. The process described above with SDR-to-HDR conversion can be generalized to other cases with HDR-to-“HDR with other peak luminance” conversion.

The HDR metadata may be created on an encoder side, and Table 4 below shows examples of the HDR metadata.

TABLE 4
Examples of HDR Metadata

```
signal_reconstruction_info( )
{
  partID
  majorSpecVersionID
  minorSpecVersionID
  payloadMode
  hdr_characteristics( )
  sdr_characteristics ( )
  for( i = 0; i < 4; i++ )
    matrixCoefficient[ i ]
  for( i = 0; i < 2; i++ )
    chromaToLumaInjection[ i ]
    for( i = 0; i < 3; i++ )
    kCoefficient[ i ]
    switch( payloadMode ) {
    case 0:
      luminance_mapping_variables( )
      colour_correction_adjustment( )
      break
    case 1:
      luminance_mapping_table( )
      colour_correction_table( )
      break
    }
    if( sdrPicColourSpace < hdrPicColourSpace ) {
      gamutMappingMode
      if( gamutMappingMode == 1 )
      gamut_mapping_variables( )
    }
}
```

The encoder in the HDR system may transmit information (e.g., additional metadata) to the decoder indicating the impact of certain tool activation or deactivation (e.g., to help the post-processor to make decisions about which tool(s) it may activate or deactivate). In examples, such information (e.g., additional metadata) may include a flag (e.g., luminance_mapping_deactivation_quality_impact), which may be added to the example syntax in Table 5 below. The flag may indicate whether the post-processor is authorized to apply the indicated tool constraint.

TABLE 5
Example HDR Metadata Indicating the
Quality Impact of Certain Constraints

```
...
if( sl_hdr_payload_mode = = 0 ) {
  tone_mapping_input_signal_black_level_offset u(8)
  tone_mapping_input_signal_white_level_offset u(8)
  shadow_gain_control u(8)
  highlight_gain_control u(8)
  mid_tone_width_adjustment_factor u(8)
  tone_mapping_output_fine_tuning_num_val u(4)
  saturation_gain_num_val u(4)
    for( i = 0; i < tone_mapping_output_fine_tuning_num_val; i++) {
    tone_mapping_output_fine_tuning_x[ i ] u(8)
    tone_mapping_output_fine_tuning_y[ i ] u(8)
  }
```

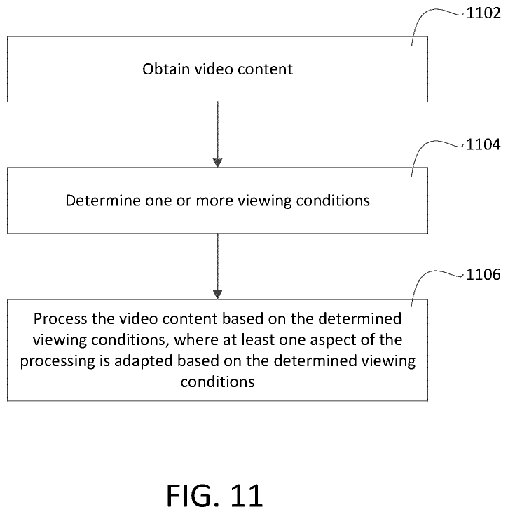

FIG. 11 illustrates example operations associated with decoding video content based on one or more viewing conditions in accordance with embodiments of the present disclosure. The operations may be performed, for example, by a video decoding device, and may include obtaining video content at 1102 and determining one or more viewing conditions associated with the video content at 1104. As described herein, the viewing conditions may include, e.g., a viewing distance (e.g., between a viewer of the video content and a display device for the video content), a viewing angle (e.g., from the viewer towards the display device), an ambient level (e.g., in a vicinity of the viewer and/or the display device), etc. The operations may further include processing (e.g., pre-processing, decoding, post-processing, etc.) the video content based on the one or more viewing conditions at 1106, during which at least one aspect of the processing may be adapted based on the determined viewing conditions. The adaptation may be associated with, for example, at least one of filtering, motion compensation, luma mapping, chroma residual scaling, motion vector refinement, optical flow-based refinement, block partitioning, or prediction of the video content.

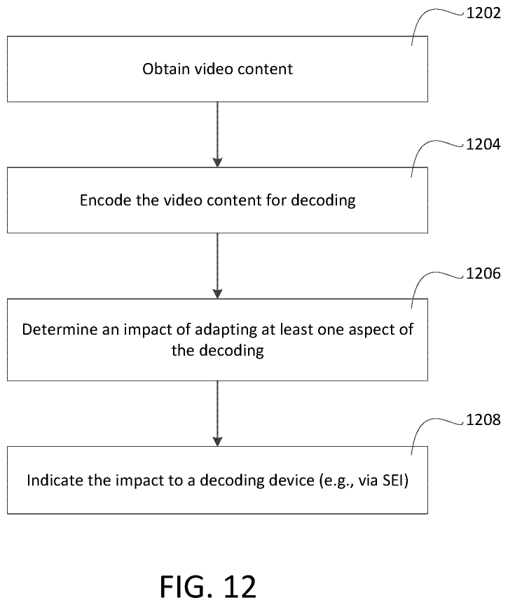

FIG. 12 illustrates example operations associated with encoding video content in accordance with embodiments of the present disclosure. The operations may be performed, for example, by a video encoding device, and may include obtaining video content at 1202 and encoding the video content at 1204 for decoding. The operations may further include determining, at 1206, an impact of adapting at least one aspect of the decoding. As described herein, the impact may include a quality impact (e.g., a quality degradation to an image or video) and/or a complexity impact (e.g., reduction in computation complexity) that may result from adapting the at least one aspect of the decoding. Once determined, the impact may be indicated at 1208 (e.g., by including an indication of the impact in a SEI message transmitted to a decoder), for example, to help a video decoding device make decisions about which aspect(s) of the decoding operation may be adjusted based on a viewing condition to achieve energy savings.

It should be noted that there is no specific restriction on the type of display device that may benefit from the example techniques described herein. For example, the display device may be a television, a projector, a mobile phone, a tablet, etc. Further, the example techniques described herein may apply to not only streaming use cases, but also teleconferencing settings. In addition, a decoder and a display as described herein may be separate devices or may be parts of a same device. For example, a set-top box may decode an incoming video and provide (e.g., subsequently) the decoded video to a display device (e.g., via HDMI), and information regarding viewing conditions such as a viewing distance may be transmitted from the display device to the set-top box (e.g., via HDMI).

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A video decoding device, comprising:
a processor configured to:
obtain a video content;
determine one or more viewing conditions associated with the video content; and
decode the video content based on the one or more viewing conditions, wherein the processor is configured to adapt at least one aspect of the decoding based on the one or more viewing conditions.

2. The video decoding device of claim 1, wherein the at least one aspect of the decoding adapted comprises at least one of a luma mapping, a chroma mapping, a chroma residual scaling, or a motion vector (MV) refinement, and wherein the processor is configured to:
based on the one or more viewing conditions, determine whether to apply at least one of the chroma mapping, the luma mapping, the chroma residual scaling, or the MV refinement.

3. The video decoding device of claim 1, wherein to adapt the at least one aspect of the decoding based on the one or more viewing conditions comprises the processor being configured to:
obtain information that indicates at least one of a quality impact or a complexity impact associated with adopting the at least one aspect of the decoding, a media environment in which the video content is consumed using a camera or sensor installed in the media environment, or whether the video decoding device is allowed to adapt the at least one aspect of the decoding; and
adapt the at least one aspect of the decoding further based on the obtained information.

4. (canceled)

5. The video decoding device of claim 3, wherein the information is obtained in a supplemental enhancement information (SEI) message.

6. (canceled)

7. (canceled)

8. (canceled)

9. The video decoding device of claim 1, wherein the processor is configured to;
determine, based on the one or more viewing conditions, whether to disable a cross component adaptive loop filter to the video content.

10. The video decoding device of claim 1, wherein the at least one aspect of the decoding adapted by the processor comprises an optical flow-based refinement, wherein the optical flow-based refinement comprises at least one of a bi-directional optical flow or a prediction refinement with an optical flow for the video content, and wherein the processor is configured to:
based on the one or more viewing conditions, determine whether to apply at least one of the bi-directional optical flow or the prediction refinement with the optical flow for the video content.

11. The video decoding device of claim 1, wherein the at least one aspect of the decoding adapted by the processor comprises at least one of a bi-prediction or a uni-prediction to the video content, wherein the processor is configured to:
based on the one or more viewing conditions, determine whether to apply the bi-prediction or the uni-prediction to the video content.

12. The video decoding device of claim 1, wherein the at least one aspect of the decoding adapted by the processor comprises the processor being further configured to:
reconstruct the video content from a standard dynamic range (SDR) to a high dynamic range.

13. A method for video decoding, the method comprising:
obtaining a video content;
determining one or more viewing conditions associated with the video content; and
decoding the video content based on the one or more viewing conditions, wherein at least one aspect of the decoding is adapted based on the one or more viewing conditions.

14. The method of claim 13, wherein the at least one aspect of the decoding adapted comprises at least one of a luma mapping, a chroma mapping, a chroma residual scaling, or a motion vector (MV) refinement, and wherein the method comprises:
based on the one or more viewing conditions, determining whether to apply at least one of the chroma mapping, the luma mapping, the chroma residual scaling, or the MV refinement.

15. The method of claim 13, wherein the method further comprises:
obtaining information that indicates at least one of a quality impact or a complexity impact associated with adopting the at least one aspect of the decoding, a media environment in which the video content is consumed using a camera or sensor installed in the media environment, or whether the at least one aspect of the decoding is allowed to be adapted;
adapting the at least one aspect of the decoding further based on the obtained information.

16. (canceled)

17. The method of claim 15, wherein the information is obtained in a supplemental enhancement information (SEI) message.

18. The method of claim 13, wherein the one or more viewing conditions comprises at least one of a distance between a viewer of the video content and a display device for the video content, a viewing angle of the viewer towards the display device, a size or resolution of the display device, a peak luminance of the display device, an average luminance of the display device, or an ambient light level in a vicinity of the viewer or the display device.

19. (canceled)

20. (canceled)

21. The method of claim 13, wherein the method comprises:
determining, based on the one or more viewing conditions, whether to apply a cross component adaptive loop filter to the video content.

22. The method of claim 13, wherein at least one aspect of the decoding adapted comprises an optical flow-based refinement, wherein the optical flow-based refinement comprises at least one of a bi-directional optical flow or a prediction refinement with an optical flow for the video content, and wherein the method comprises
based on the one or more viewing conditions, determining whether to apply at least one of the bi-directional optical flow or the prediction refinement with the optical flow for the video content.

23. The method of claim 13, wherein the at least one aspect of the decoding adapted comprises at least one of a bi-prediction or a uni-prediction to the video content, wherein the method comprises
based on the one or more viewing conditions, determining whether to apply the bi-prediction or the uni-prediction to the video content.

24. The method of claim 13, wherein the method comprises:
reconstructing the video content from a standard dynamic range (SDR) to a high dynamic range.

25-37. (canceled)

38. A non-transitory computer readable medium including instructions for video decoding, the instructions causing a processor to perform:
obtain a video content;
determine one or more viewing conditions associated with the video content; and
decode the video content based on the one or more viewing conditions, wherein at least one aspect of the decoding is adapted based on the one or more viewing conditions.

39. The non-transitory computer readable medium of claim 38, wherein the at least one aspect of the decoding adapted comprises at least one of an optical flow-based refinement or a prediction mode of the video content, wherein the optical flow-based refinement comprises at least one of a bi-directional optical flow or a prediction refinement with an optical flow for the video content, wherein the prediction comprises at least one of a bi-prediction or a uni-prediction to the video content, and wherein the instructions causing the processor to perform:
determine, based on the one or more viewing conditions, whether to apply at least one of the bi-directional optical flow or the prediction refinement with the optical flow the bi-prediction or whether to apply at least one of the uni-prediction or the uni-prediction.
